(19) United States
(12) Patent Application Publication
(10) Pub. No.: US 2026/0188998 A1
(43) Pub. Date: Jul. 2, 2026

(54) APPARATUS FOR SUPPLYING ENERGY TO AT LEAST ONE SAFETY-RELEVANT CONSUMER IN A MOTOR VEHICLE

(71) Applicant: Robert Bosch GmbH, Stuttgart (DE)

(72) Inventors: Nils Draese, Rutesheim (DE); Michael Helffenstein, Gaggenau-Freiolsheim (DE)

(21) Appl. No.: 19/129,515

(22) PCT Filed: Dec. 8, 2023
(86) PCT No.: PCT/EP2023/084837

§ 371 Date: May 13, 2025

(30) Foreign Application Priority Data
Feb. 21, 2023 (DE) 10 2023 201 502.1

(51) Int. Cl. H02H 9/02; B60R 16/023; B60R 16/03; H02H 7/20

(52) U.S. Cl. CPC H02H 9/02; B60R 16/03; H02H 7/20; B60R 16/0232

(57) ABSTRACT

An apparatus for supplying energy to at least one safety-relevant consumer in a motor vehicle. At least two switches for supplying and protecting at least one safety-relevant consumer or a plurality of safety-relevant consumers are provided. Each one of the switches is assigned its own control for switching the respective switch on or off depending on at least one control signal, including at least two independent supply paths for supplying the controls. The one supply path includes a driver stage which is fed by an auxiliary voltage. The further supply path includes a further driver stage which is fed by a further auxiliary voltage which is independent of the auxiliary voltage. At least two coupling elements for combining the output variables of the two driver stages are provided. Each of the coupling elements supplies one of the controls.

### FIELD

The present invention relates to an apparatus for supplying energy to a safety-relevant consumer in a motor vehicle.

### BACKGROUND INFORMATION

A supply network output and a method for operating a supply network are described in Germany Patent Application No. DE 10 2019 205 800 A1. The supply network output is configured for a nominal current and comprises n switches, which are sufficient for conducting the nominal current. An additional switch is provided, so that a total of n+1 switches are provided which are disposed in parallel to one another, each switch is assigned a driver, and:

n>=2.

Germany Patent Application No. DE 10 2020 107 695 A1 describes a method for configuring a vehicle electrical system of a motor vehicle, wherein at least one consumer is provided in the vehicle electrical system. Within the scope of the configuration of the vehicle electrical system, at least one of the at least one consumers is assigned an electrical module, which is in turn selected from a group of modules, wherein a first consumer criterion, which relates to a supply requirement of the at least one consumer, and a second consumer criterion, which relates to a degree of feedback of the at least one consumer, are taken into account when selecting the electrical module.

An object of the present invention is to specify an apparatus that further increases the reliability of an energy supply with a simple design. The object may be achieved by certain features of the present invention.

### SUMMARY

According to an example embodiment of the present invention, by providing at least two independent supply paths for supplying the controls, wherein the one supply path comprises a driver stage which is fed by an auxiliary voltage, wherein the further supply path comprises a further driver stage which is fed by a further auxiliary voltage which is independent of the auxiliary voltage, wherein at least two coupling elements for combining the output variables of the two driver stages are provided, wherein each one of the coupling elements supplies one of the controls, a redundant supply concept for the switch controls can be achieved. This makes it possible to supply the driver stages independently, which further increases the reliability of the energy supply and the protection of safety-relevant consumers. Specific safety-relevant requirements for a safety concept, for instance qualified according to ASIL in particular ASIL C (e.g. according to DIN ISO 26262), can thus be met. The present invention also allows a large number of controls for corresponding switches to be supplied redundantly, while still only needing to use two supply paths with corresponding driver stages. This simplifies the complexity of the circuitry needed to control a large number of switches.

In an expedient further development of the present invention, at least one current limiter is disposed between at least one of the inputs of the auxiliary voltages and at least one of the controls. This ensures that any faults in the driver stage or control or the switch (or the parallel-connected partial switching elements) do not have a critical feedback effect on the supply, in particular for the control.

In an expedient further development of the present invention, the in particular centralized current limiter is disposed between the input for the respective auxiliary voltage and the respective driver stage and/or the in particular decentralized current limiter is disposed between the respective coupling element and the driver stages. The selection between a decentralized and a centralized current limiter can be determined individually; a decentralized limiter is necessary to prevent faults in one switch from affecting the other switches.

In an expedient further development of the present invention, when a centralized current limiter is disposed in one of the supply paths, in particular decentralized current limiters are disposed between each one of the controls and the supply path not provided with the centralized current limiter. This reliably ensures feedback-free operation in the event of a fault.

In an expedient further development of the present invention, it is provided that one of the driver stages is configured as a maintenance driver stage and/or that one of the driver stages is configured as a pulse driver stage, which is used in particular when starting the motor vehicle. The pulse capability in particular enables the driver stage to quickly transition the switches from the disabled to the conductive state. Providing a further driver stage, specifically an independent maintenance driver stage, can prevent possible feedback effects of the switches on the auxiliary voltage supply and thus on the drivers of other switching stages in the event of a fault by implementing a high-ohmic connection for charge maintenance for the individual switches.

According to an example embodiment of the present invention, the maintenance driver stage is particularly preferably disposed in one of the supply paths and the centralized current limiter and the pulse driver stage are disposed in the further supply path, wherein the decentralized current limiters are respectively disposed between the maintenance driver stage and the respective coupling elements. In particular using a buffered current limiter as the centralized current limiter makes it possible to achieve rapid switch-on from the buffer, which prevents faults in the supply path from propagating to the central driver voltage.

In an expedient further development of the present invention, at least two independent control signals are provided, which cause at least one of the switches to be switched on, and/or at least two independent control signals are provided, which, in the event of a matching switch-off request, in particular coupled to one another via an AND connection, cause at least one of the switches to be switched off. On the one hand, this ensures that each of the respective control inputs is individually able to maintain the conductive state of the switch by switching through the driver stage. Providing two independent control inputs, which only together are able to transition the switch to the non-conductive state, also ensures single-fault safety. This single-fault safety makes it possible to implement particularly sophisticated safety concepts.

In an expedient further development of the present invention, at least one third switch with an associated control, in particular a gate control, is provided, wherein the control is supplied by both supply paths via a third coupling element and/or wherein at least two switches are disposed in parallel to one another. This makes it particularly easy to supply additional switches with high availability. The parallel connection further increases the fail-safety of the arrangement.

In an expedient further development of the present invention, one of the auxiliary voltages is supplied to the control, in particular the gate control, via at least one decoupling element. This ensures that no single fault leads to an unintended switch-off (becoming high-ohmic).

In an expedient further development of the present invention, it is provided that the AND connection is fed by at least one of the auxiliary voltages, wherein, in the presence of matching switch-off requests as control signals, the respective control is supplied with the auxiliary voltage, in particular via at least one decoupling element, preferably a diode. Diode decoupling in particular prevents faults in one switch or partial switching element from causing all other switches or partial switching elements to switch off.

In an expedient further development of the present invention, it is provided that the pulse driver stage includes at least one electrical buffer, in particular a capacitor, in particular comprising a multiple of the system-immanent capacitance of a switch configured as a field effect transistor, in particular a MOSFET, and/or that the pulse driver stage comprises at least one current source, and/or that the pulse driver stage comprises at least one switching means for recharging a buffer or capacitor, and/or that the pulse driver stage comprises at least one limiting resistor, and/or that the pulse driver stage is configured to initiate a switch-on of the switches using the buffer, and/or that a control signal for a switching means, which is a component of a constant current source of the pulse driver stage, is fed from a buffer or pulse memory. This makes it possible to achieve particularly rapid switch-on which, in particular in the automotive sector, is critical.

In an expedient further development of the present invention, it is provided that the current limiter comprises at least one resistor and/or a current source, in particular a constant current source, and/or an RC element and/or a buffered current limiter. In the simplest case, a resistor that is selected high enough to prevent a short circuit at the input of a switch from affecting the driver voltage, or, in the case of a decentralized solution, the other switches, is sufficient. If the resistor solution is used decentrally in front of each switch, there is no need for a centralized current limiter. To enable a short-term overload for switching transients, it is also possible to use an RC combination. The buffers of the current limiters are particularly suitable for centralized current limiting, because they allow the respective supply path to switch on quickly from the buffer, but prevent faults in the supply path from propagating to the central driver voltage.

Because the monitoring devices expediently each comprise at least one measuring amplifier for acquiring the respective characteristic variable, at least one comparator to which an output variable of the respective measuring amplifier is fed, and one memory element to which an output variable of the comparator is fed, it is easily possible to achieve redundant operation management. Safety-relevant consumers are switched off only if higher-level safety objectives require it, for example for reasons of component protection or line protection. This ensures a safe supply in the face of single faults while maintaining the safety objective. A single fault in a switch does not cause the supply path or the consumer to immediately be switched off. This leads to low overall cost with the same reliability or safety level.

Other expedient further developments of the present invention will emerge from the disclosure herein.

### BRIEF DESCRIPTION OF THE DRAWINGS

FIG. 1 shows, as an example, an embodiment example of the power distributor that connects two vehicle electrical subsystems, according to the present invention.

FIG. 2 shows a block diagram of a fail-safe energy supply of an output for an in particular safety-relevant consumer, according to an example embodiment of the present invention.

FIG. 3 shows a more detailed embodiment example of a single-fault fail-safe current measurement, according to an example embodiment of the present invention.

FIG. 4 shows a schematic illustration of the redundant operation management, according to an example embodiment of the present invention.

FIG. 5 shows a redundant driver concept, according to an example embodiment of the present invention.

FIG. 6 shows a possible implementation of the circuitry of the redundant driver concept, according to an example embodiment of the present invention.

### DETAILED DESCRIPTION OF EXAMPLE EMBODIMENTS

The present invention is illustrated schematically on the basis of an embodiment example and is described in detail in the following with reference to the figures.

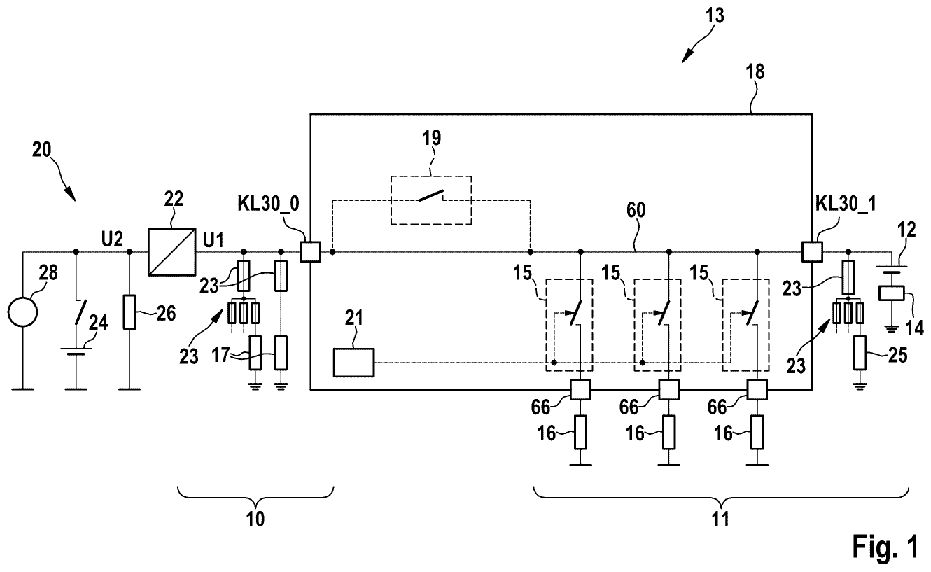

FIG. 1 shows a possible topology of an energy supply system consisting of a vehicle electrical system 13 which comprises an energy store 12, in particular a battery 12 with an associated sensor 14, preferably a battery sensor, as well as a plurality of in particular safety-relevant consumers 16 that are supplied and protected by an electrical power distributor 18. The consumers 16 are special consumers with stringent requirements or a high need for protection, generally referred to as safety-relevant consumers 16. Examples of these are an electric steering system and/or a brake system as components that absolutely have to be supplied in order to ensure steering and/or braking of the vehicle in the event of a malfunction. Characteristic variables of the respective consumer 16 are acquired separately and, in the event of a deviation from tolerable values, the respective switch 15 is opened. The vehicle electrical system 13 consists of a safety-relevant vehicle electrical subsystem 11 and a non-safety-relevant vehicle electrical subsystem 10. The safety-relevant vehicle electrical subsystem 11 can be disconnected from the non-safety-relevant vehicle electrical subsystem 10 by the power distributor 18, in particular in the event of a malfunction or critical state of the non-safety-relevant vehicle electrical subsystem 10. The safety-relevant vehicle electrical subsystem 11 is an ASIL-certified, in particular ASIL C-certified, vehicle electrical subsystem 11, for instance, (for example according to DIN ISO 26262), which comprises at least one of the safety-relevant consumers 16 and can optionally be equipped with its own energy store 12 for voltage support. The non-safety-relevant vehicle electrical subsystem 10 comprises at least one non-safety-relevant consumer 17, which may be a so-called QM consumer, for example, or a consumer the safety integrity of which is classified as QM. However, this does not exclude at least one further safety-relevant consumer being disposed in the non-safety-relevant vehicle electrical subsystem 10 as well, for example in the case of a redundant design of the safety-relevant consumers. The non-safety-relevant vehicle electrical subsystem 10 is a non-ASIL-certified vehicle electrical system.

The energy store 12 is connected to a connector (terminal KL30_1) of the power distributor 18. The sensor 14 is able to acquire an electrical characteristic variable, such as a voltage Ub at the energy store 12 and/or a current Ib through the energy store 12 and/or a temperature Tb of the energy store 12. From the ascertained electrical characteristic variables Ub, Ib, Tb, the sensor 14 can ascertain the state of charge SOC of the energy store 12, for example, or other characteristic variables of the energy store 12. A further supply branch for at least one further consumer 25 can optionally be provided at the further connector (KL 30_1) of the power distributor 18 to which the energy store 12 is also connected. The consumer 25 is protected via a safety fuse 23, for example. Other consumers 25 can be provided as well, and can likewise be protected via safety fuses 23. These consumers 25 are consumers that still have to be supplied with energy by the energy store 12 even when the switching means 19 in the power distributor 18 is being disconnected or opened; they are preferably safety-critical consumers 25 that are critical with respect to malfunctions related to supply reliability or consumers classified as QM that have to meet specific requirements after an accident. An (optional) safety-relevant or safety-critical vehicle electrical system path or vehicle electrical subsystem 11 is thus connected to the connector KL 30_1.

The power distributor 18 can have the ability to ascertain corresponding characteristic variables, such as voltage Uv and current Iv of the consumers 16. The power distributor 18 can ascertain corresponding characteristic variables of the energy store 12, such as voltage Ub and/or current Ib and/or temperature Tb. For this purpose, the power distributor 18 could comprise the corresponding sensors or receive the data from the sensor 14. The power distributor 18 also has corresponding evaluation means 21, such as a microcontroller 21, for storing or evaluating acquired variables. The evaluation means 21 is used to ascertain critical states, in particular of the safety-relevant vehicle electrical subsystem 11, such as detecting an overcurrent and/or an undervoltage or overvoltage on the vehicle electrical subsystem 11 for the safety-relevant consumer 16, 25. For this purpose, corresponding characteristic variables are acquired and compared with appropriate threshold values. A microcontroller is used as the evaluation means 21, for instance. The microcontroller or the evaluation means 21 is also able to control corresponding switch units 15 as described in more detail in the following. A switching unit 15 supplies the safety-relevant consumer 16 connected to it via an output 66 with energy or the supply voltage Ul provided via a distribution point, for example the busbar 60 or a backbone. As an example, three switching units 15 are provided, each of which supplies energy to the respective safety-relevant consumers 16 via the outputs 66.

A disconnecting switch 19 can optionally be disposed in the power distributor 18 between terminal 30_0 and terminal 30_1. A corresponding disconnection or coupling function, in particular of the two branches of the vehicle electrical system (vehicle electrical subsystem 10 for non-safety-relevant consumers 17 at connector KL 30_0; further vehicle electrical subsystem 11 for safety-relevant consumers 16, 25) can be implemented via the possibly optional disconnecting switch 19. This serves in particular as a safety function to prevent the effects of critical states such as overvoltages or undervoltages and/or overcurrents and/or thermal overloading. In the event of a malfunction, the two vehicle electrical subsystems 10, 11 can be disconnected from one another by the power distributor 18 by opening the disconnecting switch 19. The disconnecting switch 19 could include parallel-connected switching means for a fail-safe supply. The redundant monitoring or control described in more detail in the following could also be used for the disconnecting switch 19.

The vehicle electrical system 13 has a lower voltage level U1 than an optionally provided high-voltage vehicle electrical system 20; it can, for instance, be a 14 V vehicle electrical system. A DC voltage converter 22 is disposed between the vehicle electrical system 13 and the high-voltage vehicle electrical system 20. The high-voltage vehicle electrical system 20, for instance, comprises an energy storage device 24, such as a high-voltage battery, possibly with an integrated battery management system (shown as an example is a load 26, for example a comfort consumer such as an air-conditioning system or refrigerant compressor, etc. which is supplied with an increased voltage level) and an electric machine 28. High-voltage in this context is understood to mean a voltage level U2 that is higher than the voltage level U1 of the basic vehicle electrical system 13. It could be a 48-volt vehicle electrical system, for example. Especially in vehicles with an electric drive, it could alternatively be even higher voltage levels, for example 400 V or 800 V. Alternatively, the high-voltage vehicle electrical system 20 could be omitted entirely.

A battery or accumulator is described in this embodiment as an example of a possible energy storage device 12, 24. However, other energy storage devices suitable for this task, for example on an inductive or capacitive basis, fuel cells, capacitors, or the like, can alternatively be used as well.

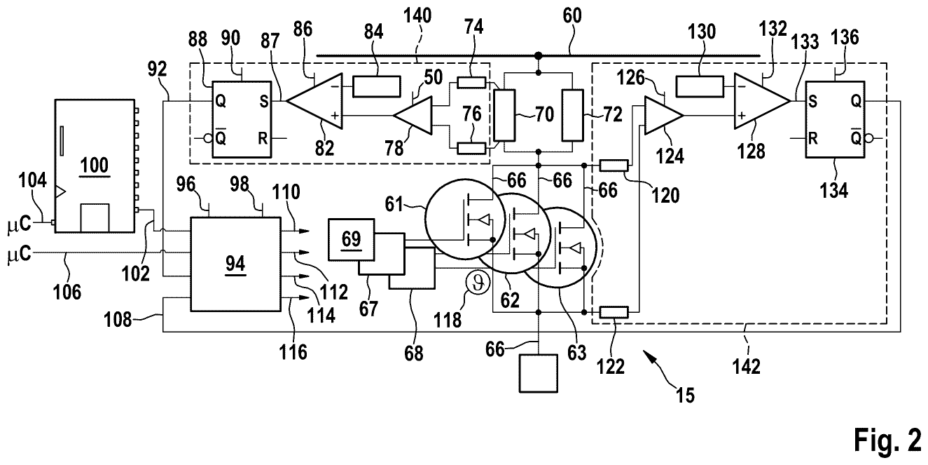

The embodiment example according to FIG. 2 discloses an example of a switch unit 15 (or possibly a disconnecting switch 19) comprising at least one, possibly two, preferably three parallel-connected switch(es) 61, 62, 63, via which the connection 66 for a safety-relevant consumer 16 can be supplied and protected with energy provided via an energy supply 60, in particular the supply voltage U1. Each one of the parallel-connected switches 61, 62, 63 is a respective component of a supply path 64. Between the energy supply 60, in particular a backbone (distribution point with a supply line or busbar in a vehicle electrical system of a motor vehicle), and the parallel-connected switches 61, 62, 63, at least one and, depending on the power requirement, two parallel-connected measuring resistors 70, 72 are provided. Other measuring means, for example inductive measuring means, etc., could alternatively be used as well.

At the first measuring resistor 70, the respective potentials before and after the measuring resistor 70 are each fed to a measuring amplifier 78 (current measurement via a current amplifier or CSA (current sense amplifier) ) via series resistors 74, 76. The series resistors 74, 76 are not absolutely necessary, but they do prevent reflections (signal interference). This is known as a series termination. The measuring amplifier 78 is supplied with energy via a supply input 80 with a supply voltage 89; preferably a first supply voltage V1 (logic supply or logic voltage: for example voltages of 5 V or 3.3 V, etc.).

The output signal of the measuring amplifier 78 reaches a comparator 82, for instance at its plus input as shown as an example in FIG. 2. This output signal from the measuring amplifier 78 is compared with a limit value 84 which is fed to the negative input of the comparator 82. Usually, the comparator 82 compares the two input signals with one another. If there is a positive or a negative difference between the two signals (voltages), the output of the comparator 82 reverses its polarity. The comparator 82 is used to detect an overcurrent Ig through the measuring resistor 70 or the measuring resistors 70, 72.

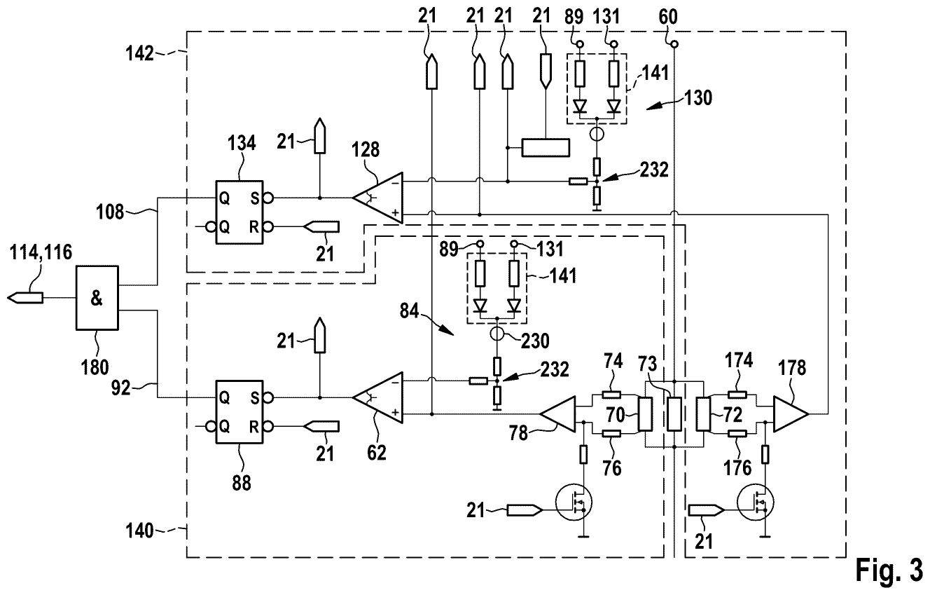

The limit value 84, 130 can be generated using appropriate circuits. To ensure functional safety, sufficient measures must be taken to prevent the change in the limit value 84 that, while the measured variable remains constant, leads to the polarity reversal at the output of the comparator 82. For this purpose, the limit value 84, 130 could be created from two reference sources, for example. One of the limit values 84, 130 could be specified by a microcontroller 21, for example by means of a PWM signal and low-pass filter or by means of a digital-to-analog output (DAC). The other limit value 130 should be implemented by an independent reference source. This can involve the use of a discrete circuit, for example using a voltage divider, Zener diode, or using integrated circuits (for example a band gap reference). The reference sources have to be supplied come from different and independent voltage sources (or supplies 89, 131). It is also possible here to supply each reference source from both supply voltages 89, 131. The two supply voltages 89, 131 have to be coupled to one another without feedback and, for example, via diodes and/or resistance (current limitation), or generally via an element to ensure feedback-free operation 141 (see FIG. 3). The two reference signals for generating the limit value 84, 130 have to be superimposed in such a way that a minimum threshold or minimum limit value 84, 130 remains after the failure of a reference source. The limit value 84, 130 can also be changed dynamically using a microcontroller 21, for instance. This makes it possible to react to specifications from the vehicle system and/or compensate component-specific changes (for example due to temperature drift). Thus, single faults such as the failure of the limit value 84 provided by the microcontroller 21 or the failure of the second limit value 130, for example provided by a discrete circuit, do not lead to the power stage or switches 61, 62, 63 being switched off.

The comparator 82 is supplied with a supply voltage 89, 131, preferably with the first supply voltage V1, via a supply input 86. An output signal 87 of the comparator 82 is fed to a memory element 88, for example a flip-flop. The memory element 88 could also be implemented as software. If the measured difference at the measuring resistor 70 and 72 is above or, depending on the method being used, below the corresponding limit value 84, the comparator 82 generates a corresponding output signal 87 (for example overcurrent detected; open switching unit 15 to “Off” for protection) or a change in the logical state of the output signal 87. If an overcurrent is detected, the output signal 87 leads to a polarity reversal at the output 92 (this can mean that an overcurrent has been detected at the measuring resistor 70, for example; as a result of which the switching unit 15 should open for protection). The output 92 of the memory element 88 could be reset via the microcontroller 21, for instance.

The memory element 88 comprises a supply input 90, via which the memory element 88 is supplied with a supply voltage 89, preferably with a redundant supply voltage. The output signal 92 of the memory element 88 is provided to a driver 94. The output signal 92 of the memory element 88 is the Off signal which, via a respective output signal 114, 116 of the driver 94, causes the respective switches 61, 62, 63 to be switched off (opened) in the event of an overcurrent. Plausibility check means, which are used to ascertain whether the switching unit 15 with the associated switches 61, 62, 63 should in fact be switched off, can be provided as a component of the driver 94. In the following embodiment examples, this plausibility check can be carried out using a corresponding logical AND connection (AND connections labeled 180 or 230 in the following embodiment examples) with further signals; in the embodiment example according to FIG. 2, for instance with an output signal 108 of a further memory element 134 as described in the following. In the embodiment example according to FIG. 2, this plausibility check logic is integrated in the driver 94. At least the memory device 88, at least the comparator 82 and at least the measuring amplifier 78 are components of a monitoring device 140 indicated as a block.

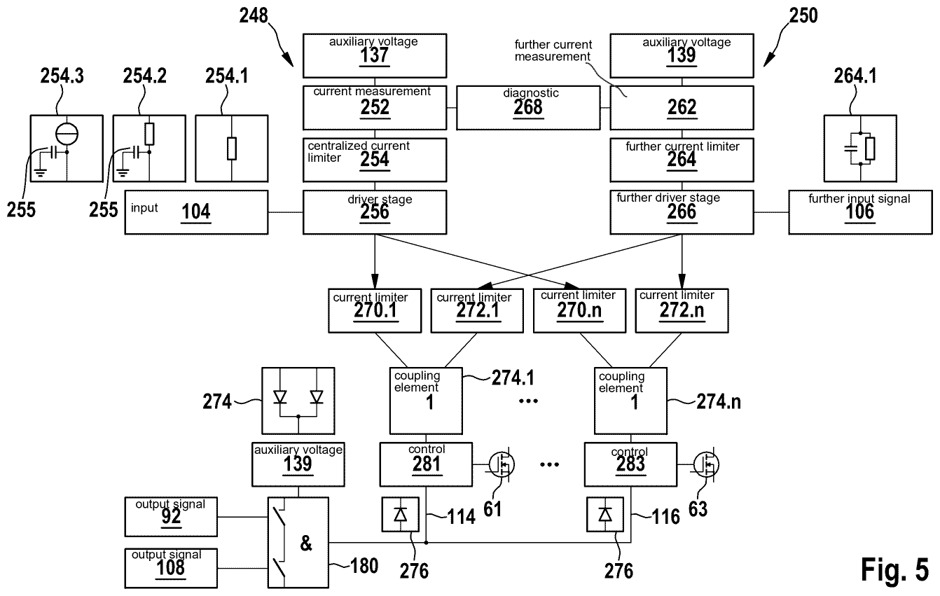

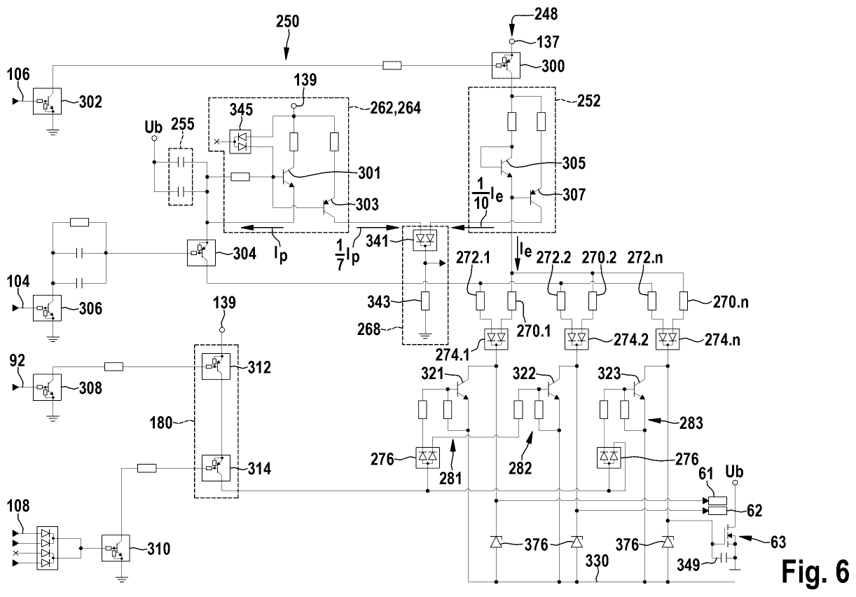

A driver voltage is supplied to the driver 94 via an input 96 and/or a further driver voltage, independent of the driver voltage supplied via the input 96, is supplied to the driver via a further input 98. Both supply voltages, also referred to as auxiliary voltages 137, 139, have to be connected to one another without feedback. The more detailed design is shown in FIGS. 5 and 6.

The driver 94 also generates further output signals 110, 112, which cause the respective switches 61, 62, 63 to be switched on (On). The output signal 110 causes activation of the first switch 61, the output signal 112 causes activation of the second switch 62, etc. The driver 94 also generates corresponding output signals for switching off the respective switches 61, 62, 63. The output signal 114 is used to switch off the first switch 61, the output signal 116 is used to switch off the second switch 62, etc. This is done via the respective drivers 67, 68, 69 for the respective switches 61, 62, 63.

The driver or drivers 67, 68, 69 can potentially also be used to carry out a temperature switch-off in the event of an overtemperature. A corresponding temperature acquisition 118 of the switching unit 15 can optionally be provided for this purpose.

A redundant input signal 102 for the driver 94 is generated by an element 100 (for generating a redundant input signal “On”), for example a further microcontroller, a register memory or the like, and made available to the driver 94. The input signal 102 can be a switch-on signal (On) for the switching unit 15. An output signal of the microcontroller 21 can be fed to the element 100 via an input 104. A further input signal 106 for the driver 94 is provided as well, which can be provided by the microcontroller 21; specifically a switch-on signal (On) for the switching unit 15. The two switch-on signals 102, 106 are OR-connected to one another. If there is at least one switch-on request via one of the signals 102, 106, the driver stage 94 generates corresponding switch-on signals 110, 112 for the switches 61, 62, 63.

The output signal of the further measuring amplifier 124 is fed to a (further) comparator 128. The comparator 128 compares the supplied output signal with a limit value 130 which is provided to the comparator 128 at its input. The comparator 128 is used to detect an overcurrent of the current flowing over the switching unit 15 if it exceeds the limit value 130. The limit value 130 for increasing the single-fault safety can in turn be created from two switch-off thresholds. One of the switch-off thresholds could be specified by the controller 21. The other switch-off threshold could be specified by a further hardware circuit, possibly supplied by a further supply voltage V2. The limit value 84, 130 can be generated using appropriate circuits. To ensure functional safety, sufficient measures must be taken to prevent the change in the limit value 84 that, while the measured variable remains constant, leads to the polarity reversal at the output of the comparator 82. For this purpose, the limit value 84, 130 could be created from two reference sources, for example. One of the limit values 84, 130 could be specified by a microcontroller 21, for example by means of a PWM signal and low-pass filter or by means of a digital-to-analog output (DAC). The other limit value 130 should be implemented by an independent reference source. This can involve the use of a discrete circuit, for example using a voltage divider, Zener diode, or using integrated circuits (for example a band gap reference). Both of these specification options are coupled, for example via the element 141 (as shown as an example in FIG. 3), to ensure feedback-free operation, for example via diodes and resistors, to a voltage divider which provides the corresponding voltage signal for the overcurrent threshold to the input of the comparator 128. Single faults of a failure of the limit value 84, 130 provided by the microcontroller 21 or the failure of the limit value 84, 130 provided by the further hardware therefore do not lead to the power stage or switches 61, 62, 63 being switched off.

The comparator 128 comprises a supply input 132, via which the comparator 128 is supplied with the supply voltage 131, in particular with the further supply voltage V2. If the output signal at the measuring amplifier 124 reaches the limit value 130, the comparator 128 generates a corresponding output signal 133, which is supplied to a further memory element 134, in particular a flip-flop, and leads to a setting of the corresponding output 108 (switching off the switching unit 15 “Off”). The further memory element 134 is supplied with energy via a supply input 136 with a supply voltage 131, in particular with the further supply voltage V2. The output signal 108 of the further memory element 134 is in turn fed to the driver 94. If the total current flowing through the switches 61, 62, 63 reaches a specific limit value 130, a corresponding off signal 108 is generated and fed to the driver 94. If both switch-off signals 92, 108 are present, the control signals for the switches 61, 62, 63 are deactivated via the driver 94. The switch-off signals 92, 108 and specific diagnostic mechanisms can be used to further diagnose and check the plausibility of the cause of the fault. At least the further memory device 134, at least the further comparator 128 and at least the further measuring amplifier 124 are components of a further monitoring device 142 indicated as a block.

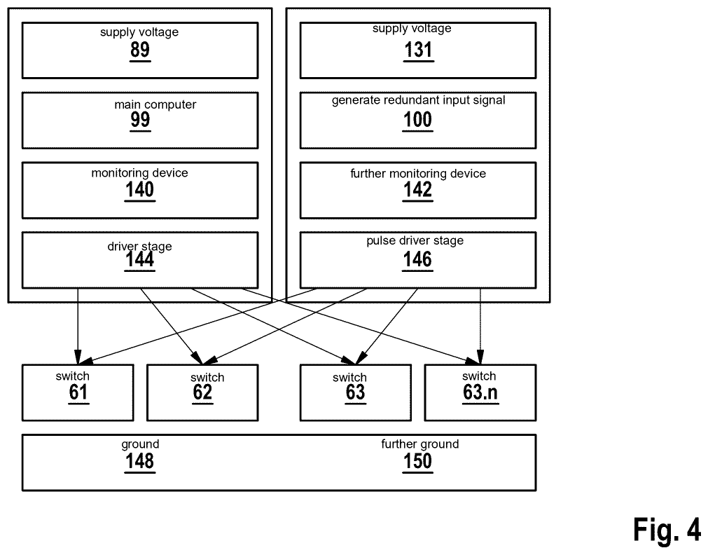

The plausibility of the switch-off request 108 is checked via the output signal 92 of the memory element 88 and vice versa. If both output signals 92, 108 of the memory elements 88, 134 signal a switch-off request, the switch unit 15 is switched off. When using field effect transistors or MOSFETs as switching elements 61, 62, 63, the plausibility of a fault detected via the measuring resistor 70 can be checked or, if necessary, further checked based on the resistance between the drain and source RDS at the MOSFET via the described measurement and software-based evaluation. The measurement above the switch (RDSon measurement) could possibly be completely omitted. To meet certain safety requirements, measurements could be taken twice across the measurement resistors 70, 72, for example, as shown in FIG. 4. The switch diagnostics could then be carried out via an extended gate driver that is able to switch the switches 61, 62, 63 on and off individually. This makes it possible to test whether the individual switch 61, 62, 63 is capable of being disabled each time it is switched off.

An element 141 for ensuring feedback-free operation and decoupling (see for example FIG. 3) can comprise two respective branches of series-connected resistors and diodes, wherein the two branches are connected to one another on the output side. The diodes are connected in such a way that they only allow current to flow from the input side, specifically from the two input signals to be combined, to the output side. This ensures the reliability of the feedback. The resistors are provided for current limitation and are dimensioned appropriately for this purpose depending on the requirements.

The concept also provides a technical implementation of a single-fault fail-safe current measurement with latent fault detection, as a result of which a single fault in the current measurement does not lead to a violation of the “safe supply” safety objective. A latent fault in the switches 61, 62, 63 can moreover be detected in the power stage.

As shown in FIG. 3, the monitoring device 140 comprises the measuring amplifier 78, the comparator 82, and the memory element 88. The limit value is created by a voltage divider 232, which is redundantly supplied by the supplies 89, 131 that are coupled to one another without feedback via the element 141, and fed to an input of the comparator 82. The further monitoring devices 142 comprises the measuring amplifier 178, the further comparator 128 and memory element 134. The limit value of the further comparator 128 is created redundantly supplied by the supply 89, 131 via a voltage divider 232. Corresponding output signals of the measuring amplifiers 82, 178 are tapped as well, and fed to the microcontroller 21 for further evaluation.

The block diagram according to FIG. 4 summarizes the underlying concept for ensuring that the requirements relating to safe supply and safe disconnection are met with appropriate integrity. The redundant operation management is characterized by at least two independent and feedback-free as well as decoupled control paths of the switching elements 61, 62, 63. For this purpose, all of the necessary supply voltages 89, 131 or auxiliary voltages 137, 139, the failure of which can cause the violation of a safety objective, have to be implemented redundantly. All of the components listed in FIG. 4 have to moreover be supplied with one or both of the redundant sources. In the concept shown here as an example, each source is connected via an element 141 to ensure feedback-free operation and decoupling. This both prevents feedback and suppresses further cross effects. The microcontroller 21 as the main processor is supplied with the required operating and reference voltages from the sources of the supply 89, for example, and a further auxiliary computer 100 from the sources of further supply 131.

The embodiment example according to FIG. 4 is characterized by a highly integrated driver circuit. The number of components needed for control can thus be reduced to a minimum. The introduction of a pulse driver stage 146 and a maintenance driver stage 144 furthermore enables the feedback-free use of the auxiliary voltage supplies. A single fault, such as a short circuit of the gate (driver 67, 68, 69) of a power semiconductor (switch 61, 62, 63) to source, still leads at most to the loss of one of the switches 61, 62, 63, whereas the remaining switches 61, 62 continue to be available. A single fault of the switch-off signal 92, 108 does not lead to the switching unit 15 being switched off. A single fault in the event of failure of the microcontroller 21 does not lead to the channel being switched off, because the switch-on signal 102 is carried out via temporary storage in the auxiliary computer or register 100.

This ensures that, even in the event of a failure of a supply unit, in particular the failure of a main source, the supply paths 64 remain active.

For this purpose, all of the circuit elements have to be supplied from the first supply 89 and from the further supply 131. This also ensures that the, in particular safety-relevant, consumer 16 connected to the connection 66 is reliably connected to the main distribution or energy supply 60 with the required integrity.

For both supplies 89, 131 in FIG. 3, it is recommended that heterogeneous (inhomogeneous) redundancy concepts be used. This could require the use of two different conversion units (linear, DC/DC, etc.), for example. Connecting the respective circuit units (e.g. generation of the switch-on signal, drivers, registers, microcontrollers, auxiliary voltages, logic voltages, etc.) via the element 141 to ensure feedback-free operation and decoupling, prevents faults in one of the supplies 89, 131 or in one of the connected components or structural elements from having negative feedback effects on one of the common supplies 89, 131.

The two supplies 89, 131 can be designed to have different power levels, because the further supply voltages connected to them are connected in such a way that the supply path 64 can maintain emergency operation if necessary, but (for example due to a high-ohmic and a low-ohmic connection to one of the two supplies 89, 131) does not guarantee start-up or rapid switch-on. Thus, in the case of a single fault, one of the two sources is always available to be used.

It is moreover also possible to optimize one of the two supplies 89, 131 for low quiescent current consumption. This can in particular be advantageous for a faster change from the sleep or standby operating states to normal operation or steady state. To maintain a low quiescent current consumption, for example 100 μA, power switches have to be opened. If a supply 89, 131 is needed in sleep mode as well, this is implemented via a further, significantly lower power, quiescent current-optimized and cost-efficient source. This makes it possible to achieve significantly shorter wake-up times. Regardless of the reason for waking up (ignition signal K115, CAN active, consumer current exceeds the wake-up threshold, etc.) , the output channel 15 can bring the consumer 16 to full power within<1 ms. When using the described fast wake-up procedure, the supplies 89, 131 are either switched off or relieved to attain low quiescent current consumption. This achieves the restrictive quiescent current requirements and fast wake-up and thus in particular quickly ensures operational readiness. If output channels with safety integrity are activated quickly (fast wake-up), diagnostic functions may have to be carried out until the necessary safety integrity of the connected consumer is provided. This therefore very quickly ensures full power (<1 ms) and full safety integrity after the microcontroller 21 boots up, and also the execution of diagnostic functions accordingly provided for the switching unit 15 and the overall system. The duration can be <250 ms, for example. If all of the diagnostic results are within the specified ranges, full safety integrity can be confirmed for the overall system and the vehicle can thus be enabled to start driving immediately, for example.

Two independent logic or control units (for example the main computer 99, such as a microcontroller 21, and an auxiliary computer 100, such as a registrar) redundantly provide the status information and the control information of the output channels or supply paths 64. Preferably, a high-performance main computer 99 is installed, that is protected against malfunctions by an extensive architecture and thus by comprehensive monitoring concepts. The auxiliary computer 100, in the simplest case merely an independent status and control register, can maintain the current operating state and control signals independent of the main computer 99 or its supply in the event of a fault. The corresponding output signals (output signal 102 of the auxiliary computer 100, output signal 106 of the microcontroller 21) are both sent to the driver 94 for the switching unit 15.

Two independent monitoring devices 140, 142 (as described as an example for FIGS. 2-3) are provided, which independently monitor the state of the supply paths 64 (between 60 and 66) for faults, such as overload, in order to request a disconnection of the conductive connection between the input 60 and the output 66 in the event of a fault. This independence must ensure that there are no (or only justifiably unlikely) faults in which both monitoring devices 140, 142 erroneously request disconnection at the same time. As described above, the protective devices 140, 142 comprise respective measurement resistors 70, 72, 73 or voltage taps at the switching means 61, 62, 63, respective measuring amplifiers 78, 124, 178 and/or respective comparators 82, 128 for evaluating the measurement signals of the measuring amplifiers 78, 124, 178 and/or respective memory elements 88, 134 for temporarily storing specific status information and/or respective logic elements 180 for checking the plausibility of a switch-off request or a switch-on request. The monitoring device 140 and the further monitoring device 142 in turn respectively comprise the not separately depicted memory device 80, 134, the not separately depicted comparator 82, 128, and at least the not depicted measuring amplifier 78, 124, 178.

Also provided are n decoupled driver stages 67, 68, 69, etc. and switches 61, 62, 63, etc. The switches 61, 62, 63, etc. serve to provide the low-ohmic connection between the main supply 60 and the output 66 for supplying the connected consumer by parallel-connecting, for example, MOSFETs or IGBTs as power switches in the respective supply paths 64. The driver stages 67, 68, 69 are internally structured in such a way that one of the two independent logic units 99, 100 is always able to initiate or maintain the conductive status. Due to its pulse capability, the pulse driver stage 146 shown in the example is able to quickly transition the switches 61, 62, 63 from the disabled state to the conductive state. However, this pulse capability increases the risk that a single fault in one of the switches 61, 62 or 63 will affect the other driver stages 67, 68, or 69 via a coupling. Ultimately then, a single fault in one of the power switches 61, 62, 63 can affect the entire channel 15. Introducing an independent maintenance driver stage 144, for example supplied from two supply units 89, 131, makes it possible to avoid the feedback effects caused by a high-ohmic connection of the faulty path to the supply source.

The concepts of ensuring feedback-free operation and decoupling by means of corresponding elements 141 or blocks 141 and the pulse and maintenance driver stage 146, 144 always ensures that, in the event of a single fault in a power switch 61, 62, 63, the greatest impact will the failure of a MOSFET or switch 61, 61, 63. All of the other power switches 61, 62, 63, and also any output channels connected in parallel and supplied from the same sources, remain active.

The drivers 67, 68, 69 are internally structured in such a way that only the two monitoring devices 140, 142 together are able to interrupt the conductive path between the input 60 and the output 66. The two disconnection requests of the two monitoring devices 140, 142 are combined only once they are so close to the respective switches 61, 62, 63, 63.n that there are no single faults that deactivate multiple switches 61, 62, 63, 63.n at the same time.

The switch-near connection also minimizes the number of switch-specific components. The number of switches n is selected such that the higher-ohmic failure of one of the subpaths or supply paths 64.1 . . . n does not jeopardize the safety objective of a reliable supply of the loads connected to the output 66, in particular safety-relevant consumers 16, for a sufficiently long fault tolerance time. With their special internal structure, the drivers 67, 68, 69 ensure that even faults in a single switch 61 do not adversely affect other switches 62, 63, 63n, which violates the safety objective of providing a sufficiently low-ohmic connection (for example in the implementation of a short circuit between gate and source, which has to be encapsulated within the driver 67, 68, 69 in order to prevent it from affecting the other switches 62, 63, 63n).

A redundantly powered ground concept, indicated by a ground 148 and a further ground 150, is provided as well. This ensures that the internal reference ground of the control device has a sufficiently high overall availability.

FIG. 5 shows a redundant driver concept. This driver concept is used in the driver 94 shown in FIG. 2, for instance. It comprises two redundant supply paths 248, 250. The one supply path 248 is fed by the auxiliary voltage 137. The other supply path 250 is fed by the further auxiliary voltage 139. The two auxiliary voltages 137, 139 are independent of one another, which ensures an independent supply of the drivers 67, 68, 69 or the associated switches 61, 62, 63.

The one auxiliary voltage 137 can preferably be active when the microcontroller 21 is active. Trickle charging can be implemented via auxiliary voltage 137 as described in the following. The auxiliary voltage 137 in particular also serves to supply the internal peripherals. The further auxiliary voltage 139 can preferably be continuously active, in particular in order to enable a quick start of the motor vehicle.

A current measurement 252 is provided for the auxiliary voltage 137. A further current measurement 262 is provided for the further auxiliary voltage 139. The respective output signals of the current measurements 252, 262 are fed to a diagnostic 268. The diagnostic 268 is used to diagnose driver faults or gate faults.

An in particular centralized current limiter 254 can optionally be provided for the auxiliary voltage 137. An in particular centralized further current limiter 264 is provided for the further auxiliary voltage 139. In the simplest case, a resistor 254.1 could be provided as a possible current limiter 254, 264. The resistor 254.1 is selected to be sufficiently high that, in the event of a short circuit at the input of an individual switching element or switch 61, 62, 63, the feedback effect on the driver voltage or the auxiliary voltage 137, 139 is prevented. To enable a short-term overload for switching transients, a RC element 254.2 can also be used as the current limiter 254, 264. Having a centralized current limiter 254, 264 in each one of the supply paths 248, 250, in which a capacitor is respectively connected to ground as a buffer 255 (electrical buffer 255) that enables the respective supply path 248, 250 to switch on quickly from the buffer 255, in particular prevents faults in the respective supply paths 248, 250 from propagating to the respective central driver voltage or auxiliary voltage 137, 139.

The auxiliary voltage 137, which may be provided by a driver stage 256, possibly embodied as a maintenance driver stage 144 or as an activation driver stage or pulse driver stage 146, is fed to a possibly provided, in particular decentralized, current limiter 270.1, 270.2, 270.n. Each respective, in particular decentralized, current limiter 270.1, 270.2, 270.n is assigned to a driver 67, 68, 69 or control 281, 282, 283, in particular gate control (as a component of the respective drivers 67, 68, 69), for the associated switching means 61, 62, 63. The further auxiliary voltage 139 or driver voltage possibly provided by the further driver stage 266 is fed to a possibly to be provided further, in particular decentralized, current limiter 272.1 for the control 281 of the first switching means 61. The auxiliary voltage 137 or driver voltage possibly provided or forwarded by the driver stage 256 is fed to a possibly to be provided, in particular decentralized, nth current limiter 270.n, which is assigned to a respective control 283 for the associated nth switching means 63. The further auxiliary voltage 139 or driver voltage possibly provided or forwarded by the further driver stage 266 is fed to a possibly to be provided nth further, in particular decentralized, current limiter 272.n for the nth control 283 of the nth switching means 63. The output variables of the current limiter 270.1 and the further current limiter 272.1 (i.e. the two auxiliary voltage in 137, 139 or driver voltages from the two supply paths 248, 250) are fed redundantly to the control 281 via a coupling element 274.1 (in particular an OR connection). The same applies to each one of the further controls 282, 283, which are each redundantly supplied by the auxiliary voltage 137, 139 or driver voltages using the respective current limiter 270, 272; 254, 264. The output variables of the nth current limiter 270.n and the further nth current limiter 272.n (i.e. the two auxiliary voltage in 137, 139 or driver voltages from the two supply paths 248, 250) are fed redundantly to the nth control 283 via an nth coupling element 274.n (in particular an OR connection). In the simplest case, the coupling element 274 can be configured as a link or OR connection in the form of a double diode 274.1 (which connects the two supplied branches to one another via a diode) and applied to the control input of a respective partial switching element.

The switch-on signal 104 controls the driver stage 256, which controls the supply of auxiliary voltage 137 to the respective drivers 67, 68, 69. The further switch-on signal 106 controls a further driver stage 266, which controls the supply of the further auxiliary voltage 139 to the respective drivers 67, 68, 69. Two independent switch-on signals (“On”) 104, 106, which act as control signals on the respective driver stages 256, 266, enable said stages to individually maintain or activate the conductive state of the switching means 15 consisting of the individual switches 61, 62, 63, for example when the motor vehicle is started.

The design of the driver stage 256, 266 and/or the current limiter(s) 254, 264; 270, 272 and/or the coupling element 274 ensures that any faults in the drivers 67, 68, 69 or in the control 281, 282, 283 or the switching means 15 or the individual switches 61, 62, 63 (within a supply channel for supplying the respective output 66 for a safety-relevant consumer 16) or other components do not have a critical feedback effect on the supply. This feedback-free operation makes it possible to reliably supply multiple, in particular more than only two, switches 61, 62, 63 can be reliably supplied with two auxiliary voltages 137, 139 within a control device. This feedback-free operation can be implemented either centrally (by means of corresponding current limiters 254, 264 in the respective supply paths 248, 250) and/or decentrally (corresponding current limiters 270.n, 272.n) for each individual switch input or associated individual control 281, 282, 283 for the respective switch 61, 62, 63 and/or by combining centralized and decentralized current limiters 252, 262; 270.n, 272.n. Thus, only one of the current limiters 254, 264; 270.n, 272.n (at least two centralized current limiters 254, 264 (for each supply path 248, 250 or auxiliary voltage 137, 139) ) or n decentralized current limiters 270.n, 272.n are required. The selection between a decentralized and a centralized current limiter 252, 262; 270.n, 272.n can be determined individually; at least one decentralized limiter is needed to prevent faults in one switch 61, 62, 63 from affecting the other n−1 switches 61, 62, 63.

The centralized current limiter 254 (for the driver stage 256, 144) could therefore be omitted in the embodiment example according to FIG. 5. But in that case then, the local or decentralized current limiter 270.1 and the local or decentralized current limiter 270.n are absolutely necessary in order to provide at least one current limiter for this path. One the other hand, if only the centralized current limiter 264 (for the driver stage 266, 146) is provided for the auxiliary voltage 139, the decentralized current limiters 272.1, 272.n can be omitted. In this concept, the driver stage 266 could be configured as a pulse driver stage 146 (used for short-term activation) with the upstream centralized current limiter 264 (and the not absolutely necessary decentralized current limiter 272.1, 272.2, 272.n). The driver stage 256 could be configured as a maintenance driver stage 144. The centralized current limiter 254 in front of the maintenance driver stage 144 can be omitted; but the decentralized current limiters 270.1, 270.2, 270.n downstream of the maintenance driver stage 144 have to be provided.

The switches 61, 62, 63 are respectively the components of the switching unit 15 within a channel (see FIG. 1, which shows three channels as an example). In a control device or power distributor 18, multiple channels, each with its own redundant driver 67, 68, 69 or controls 281, 282, and 283, can be supplied from just two auxiliary voltages 137 and 139.

The switch-off logic has to ensure that no single fault leads to an unintended switch-off (change to the high-ohmic state) of more than one switch 61, 62, 63 of the n+1 switching elements which are connected in parallel and each redundantly supply one channel or safety-relevant consumer 16. Two independent switch-off signals (“Off”) 92, 108 are fed to an AND connection 180. Opening of the switches 61, 62, 63 is initiated only if both switch-off signals 92, 108 indicate a switch-off request (“Off”). Therefore a single fault, for example in the case of redundant current detection, does not trigger a switch-off of the safety-relevant consumer 16. The switch-off request can be routed to the control 281, 282, 283 via respective decoupling elements 276, for example diodes, via this AND connection 180. The diode decoupling prevents faults in a partial switching element or switch 61, 62, 63 or driver 67, 68, 69 from triggering a switch-off of all other switches 61, 62, 63 (also in other channels). Faults in which single faults in a partial switching element or switch 61, 62, 63 prevent all other switches 61, 62, 63 from being switched off, represent a latent fault at the overall system level and can be detected using latent fault diagnostics. Within each switch 61, 62, 63, or associated driver 67, 68, 69, the switch-off signal (output signal of the AND connection 180) is used to transition the respective switches 61, 62, 63 (for example MOSFETs or IGBTs) to the disabled state.

A possible implementation of the circuitry of the block diagram according to FIG. 5 is described as an example in the following in connection with FIG. 6,. The further auxiliary voltage 139 for the further supply path 250 can be supplied via an input. The further auxiliary voltage 139 is a certain amount higher than the supply voltage Ub (such as the battery voltage Ub) and could, for instance, be 24 V (for an example battery voltage Ub of 12 V). This driver voltage controls the switches 61, 62, 63, which are in particular configured as MOSFETS. To switch on a switch 61, 62, 63 embodied as a (for example NPN) MOSFET, the system-immanent capacitance 349 between gate and source has to first be charged. To switch through the switch 61, 62, 63, the gate voltage (in the form of the applied voltage 137, 139) has to be reliably above the battery voltage Ub to which the drain terminal of the MOSFET 61, 62, 63 is connected.

The controls 281, 282, 283 are switched on while being supplied with the further auxiliary voltage 139 or driver voltage using the switch-on signal 104. The base of a switching means 306 configured as a transistor is controlled via the switch-on signal 104. The switching means 306 is connected to an RC element and also to ground. A further switching means 304 is controlled via the RC element. The further switching means 304 is likewise configured as a transistor. The base of the further switching means 304 is controlled by the switching means 306 via the RC element. If the further switching means 304 is controlled via the switch-on signal 104, the further auxiliary voltage 139 is in principle available, current-limited (current limiter 264), at the output of the further switching means 304 and is fed to the controls 281, 282, 283 of the respective switches 61, 62, 63 via the associated coupling elements 274.

The pulse memory 255 formed from at least one capacitance (in this embodiment example two parallel-connected capacitances) is supplied with energy via the battery voltage Ub. On the one hand, the base terminals of the transistors 301, 303 of the two branches of the current source are controlled via the output of the pulse memory 255. On the other hand, the output is put into contact with the transistor 301, which is used to generate the pulse current Ip, and is thus also connected to the input of the further switching means 304.

The control signal for the switching means 301 can be generated via the buffer 255, possibly in cooperation with the supply voltage U0 or the battery voltage Ub. The one potential of the buffer 255, configured as a capacitor or as a parallel connection of two capacitors, is therefore at the supply potential, for example of the battery voltage Ub. The other connector of the buffer 255 is put into contact with the base of the switching element 301 configured as a transistor and the further switching element 303 likewise configured as a transistor via a resistor. The other connector of the buffer 255 is also connected to the output of the switching element 301, in particular to the collector of the transistor of the switching element 301. The input or the collector of the switching means 301 configured as a transistor is put into contact with the further connector of the current limiter 264. Both the output of the switching means 301 and the further connector of the buffer 255 in contact with it are fed to the further switching means 304, in particular configured as a transistor, particularly preferably the emitter of the transistor 304.

The connection point potential of the further auxiliary voltage 139 feeds a constant current source serving as the centralized current limiter 264 via the supply branch 250. The pulse memory 255 is slowly charged. Initially, a very low current flows between the emitter and the base of the transistor 301 via the relatively high-ohmically dimensioned resistor between the base of the transistor 301 and the pulse memory 255. This also creates a voltage drop at the negative feedback resistor between the connector for the auxiliary voltage 139 and the emitter of the transistor 301. Beyond a certain voltage drop at this resistor, the current flows over the double diodes 345. This reduces the current at the base of the transistor 301. The collector current at the transistor, specifically the pulse current Ip (as the output current Ip of the pulse driver stage 146), controlled by the base current is reduced accordingly. This makes it possible to implement a current source 254.3 that acts as the current limiter 264. If a voltage of 0.7 V is applied to the resistor, the transistor 301 (and the transistor 303) is deactivated. The associated circuit of the current limiter 264 could be dimensioned such that a maximum current of approx. 2.5 mA is achieved. This ensures a sufficiently feedback-free operation with the further auxiliary voltage 139.

The buffer 255 is operated in conjunction with the further switching means 304 via the charge transfer of the buffer 255 like a pulse source to control the switching means or switch through the switching means 301, so that the further auxiliary voltage 139 is available to the controls 281, 282, 283 very quickly after activation of the switch-on request 106 in order to switch on the switches 61, 62, 63 and ensure the supply of the safety-relevant consumer 16. The capacitance of the buffer 255 is, for instance, ten times greater than the junction capacitance of the switch 61, 62, 63 configured as MOSFETs, and could be on the order of 1 ηF, for example. The corresponding dimensioning of the circuit is accordingly simple.

The further output of the further switching means 304 is electrically conductively connected to a respective resistor (as a possible further decentralized further current limiter) 272.1, 272.n, and then connected to the respective coupling element 274.1, 274.n. The other respective resistor(s) 272.1, 272.n is/are relatively low-ohmic, for example on the order of 250 or 200 Ω. The relatively low-ohmic connection and corresponding buffering enable rapid switch-on of the switches 61, 62, 63. The resistors are used in particular for balancing, not primarily as a decentralized current limiter 272.1, 272, 2, 272.n.

A current measurement 262 of the pulse current Ip is provided via a resistor 343. Specifically, the constant current source (as the current limiter 264) and the current measurement 262 are designed such that the further auxiliary voltage 139 reaches the diagnostics 268 via a branch (via an upstream resistor and a transistor 303) as the current mirror of the pulse current Ip. This branch is dimensioned such that a certain portion of the flowing pulse current Ip is routed to the diagnostics 268, for example depending on the size of the resistors, for example 1/7 Ip.

The pulse current Ip reaches the further switching means 304 via a further branch (via an upstream resistor and a transistor 301), and/or, if applicable, the coupling element 274.1, 274.2, 274.n via the current limiter 272.1, 272.2, 272.3 or 272.n. The current limiter 272.1, 272.2, 272.3 or 270.n is configured as an electrical resistor (for example on the order of 200 Ohms). The current limiter 272.1, 272.2, 272.3 or 272.n serves to balance the pulse current Ip with respect to the maintenance current Ie as described in the following.

The supply path 248 is supplied via the auxiliary voltage 137.

The switching means 300 disposed in the supply path 248 can be controlled or activated by the switch-on signal 106 via a further switching means 302. Following the rapid activation of the switches 61, 62, 63 using the pulse driver stage 146, the maintenance driver stage 144 is also switched on in parallel via an activation of the switching means 300. The maintenance driver stage 144 is supplied by the auxiliary voltage 137. The auxiliary voltage 137 (like the further auxiliary voltage 139) is a certain amount higher than the supply voltage Ub, particularly preferably on the order of 12 V higher than the supply voltage Ub. The switching element 300, in particular a transistor, is activated via the switch-on signal 106 via the control input of the switching element 302, the output signal of which forms the control signal for the switching element 300, so that the auxiliary voltage 137 at the input is switched through. The maintenance current Ie (output current Ie of the maintenance driver stage 144) is applied via a resistor and a transistor 305 via a first branch at the output of the switching means 300.

For each control 281, 282, 283 or each switch 61, 62, 63, the maintenance current Ie reaches the decentralized current limiter 270.1, 270.2, 270.n. The decentralized current limiter 270.1, 270.2, 270.n is configured as an electrical resistor (for example on the order of 10k). After the respective decentralized current limiter 270.1, 270.2, 270.n, the current Ie is passed over the respective coupling elements 274.1, 274.2, 274.3, 274.n to the respective control 281, 282, 283 for the associated switches 61, 62, 63. As described above, the coupling element 174 is made up of two diodes, for instance, which couple the two supplied inputs (the proportional pulse current Ip supplied via the output of the switching means 304 via the resistors 272.1, 272.2, 272.n; and the proportional maintenance current Ie supplied via the current limiter 270.1, 270.2, 270.n) to an output without feedback.

For the purpose of current measurement 252, the output of the switching means 300 branches off the first branch, which includes the transistor 305, into another branch, which consists of a further transistor 307 and an upstream resistor. The base of the further transistor 307 is electrically conductively in contact with the output of the further transistor 305. By appropriately dimensioning the resistors, a certain percentage of the maintenance current Ie is supplied to the diagnostics 268, for example 1/10 Ie. For this purpose, the output of the further transistor 307 is fed to the diagnostics 268. The circuit thus serves as a current mirror. The current flow (a measure of Ip, Ie) of the two auxiliary voltages 137, 139 can be measured via the diagnostics 268. The diagnostics 268 can preferably in turn comprise a coupling element 341 consisting of two diodes that combine the supplied proportional currents Ip, Ie to a single output for further evaluation. The evaluation or acquisition of the currents Ie, Ip is carried out via the measuring resistor 343. The measuring resistor 343 is supplied with the output of the coupling element 341; its other terminal is connected to ground.

The controls 281, 282, 283 each comprise at least two parallel branches. The output of the respective coupling element 274.1, 274.2, 274.n branches into the two parallel branches. The first branch reaches a branching point, via which a control signal is applied to the associated switching means 61, 62, 63. A cathode of a Zener diode 376 is also in contact with the branching point, while the anode of the Zener diode 376 is connected to a common reference potential 330. The further branch of the respective control 281, 282, 283 is likewise connected to the output of the associated coupling element 274.1, 274.2, 274.n, which, too, can be connected to the common reference potential 330 via respective switching means 321, 322, 323. The respective switching means 321, 322, 323, which are preferably configured as transistors, are switched through via a corresponding control of the base when the switch-off signals 92, 106 match, so that the output of the associated coupling elements 274.1, 274.2, 274.n is drawn to the reference potential 330 and thus no corresponding activation of the switching means 61, 62, 63 in the sense of switching on occurs. The switching means 61, 62, 63 are therefore switched off.

The switch-off signals 92, 108 respectively control further switching means 308, 310 (for example controlled via the base of switching means 308, 310 embodied as transistors). As an example, multiple switch-off signals 108 (for instance from different sources) could also be combined and control the switching means 310. The output signals of the correspondingly controlled switching means 308, 310 are fed to an AND connection 180. The AND connection 180 comprises two further switching means 312, 314, for example, which are preferably configured as transistors, are connected in series and the switching path of which can be supplied with one of the auxiliary voltages 137, 139, in particular the further auxiliary voltage 139. If there are matching switch-off requests 92, 106, both switching means 312, 314 of the AND connection 180 switch through, so that the further auxiliary voltage 139 or the driver voltage is present at the output of AND connection 180.

The output signal of the AND connection 180 is routed to a decoupling element 276, in the embodiment example to two decoupling elements 276. The decoupling element 276 comprises at least one diode, which is disposed between the output of the AND connection 180 and the input of the respective control 281, 282, 283 in conducting direction. The input signal of the decoupling element 276 can also be fed to the further control 282 via a further diode. The output signal of the decoupling element 276 is fed to the control 281 (for the first switch 61) as well as to the control 282 (for the second switch 62). The output signal of the AND connection 180 is forwarded to the control 283 (for the third switch 63) via a further decoupling element 276.

The output signals of the respective decoupling elements 276 control the associated switching means 321 (for the control 281), switching means 322 for the control 282 and switching means 323 for the control 283. They are therefore each connected to the base of the switching means 321, 322, 323 embodied as a transistor.

The output signal of the coupling element 274.1 is connected to the control 281 or to the transistor 321 and, via a branching point, to both the first switching means 61 and the reference potential via a Zener diode 376. The output signal of the coupling element 274.2 is connected to the control 282 or to the transistor 322 and, via a branching point, to both the second switching means 61 and the reference potential via a further Zener diode 376.2. The output signal of the coupling element 274.n is connected to the control 283 or to the transistor 323 and, via a branching point, to both the third or nth switching means 63 and the reference potential via a further Zener diode 376.n. If there are matching switch-off requests 92, 108, the respective switching means 321, 322, 323 are controlled such that switch-on signals no longer reach the switches 61, 62, 63 as described above. The switches 61, 62, 63 are then opened.

The power distributor 18 is, for example, disposed in a 12 V vehicle electrical system 13 in a motor vehicle directly at the interface between the non-safety-relevant vehicle electrical subsystem 10 and the safety-relevant vehicle electrical subsystem 11, in particular the ASIL-certified vehicle electrical subsystem 11. However, its use is not limited to this.

1-15. (canceled)

16. An apparatus for supplying energy to at least one safety-relevant consumer in a motor vehicle, comprising:
at least two switches configured to supply and protect at least one safety-relevant consumer or a plurality of safety-relevant consumers, each respective switch of the switches being assigned its own control for switching the respective switch on or off depending on at least one control signal;
at least two independent supply paths for supplying the controls, wherein one of the supply paths includes a driver stage which is fed by an auxiliary voltage, and a further one of the supply paths includes a further driver stage which is fed by a further auxiliary voltage which is independent of the auxiliary voltage; and
at least two coupling elements configured to combine output variables of the driver stage and the further driver stage, wherein each of the coupling elements is configured to supply a respective one of the controls.

17. The apparatus according to claim 16, wherein at least one current limiter is disposed between at least one input of the auxiliary voltage and the further auxiliary voltage and at least one of the controls.

18. The apparatus according to claim 16, wherein: (i) a centralized current limiter is disposed between an input for the auxiliary voltage and the driver stage, and between an input for the further auxiliary voltage and the further driver stage and/or (ii) a decentralized current limiter is disposed between a respective one of the coupling elements and the driver stage and another respective one of the coupling elements and the further driver stage.

19. The apparatus according to claim 16, wherein a centralized current limiter is disposed in one of the supply paths, and decentralized current limiters are respectively disposed between each one of the controls and the supply path that is not provided with the centralized current limiter.

20. The apparatus according to claim 16, wherein one of the driver stage and the further driver stage is configured as a maintenance driver stage, and/or one the driver stage and the further driver stage is configured as a pulse driver stage, which is used when starting the motor vehicle.

21. The apparatus according to claim 16, wherein a maintenance driver stage is disposed in one of the supply paths, and a centralized current limiter and a pulse driver stage are disposed in another of the supply paths, and wherein decentralized current limiters are respectively disposed between the maintenance driver stage and respective coupling elements.

22. The apparatus according to claim 16, wherein: (i) at least two independent control signals are provided, which cause at least one of the switches to be switched on, and/or (ii) at least two independent control signals are provided, which, in the event of a matching switch-off request, coupled to one another via an AND connection, cause at least one of the switches to be switched off.

23. The apparatus according to claim 16, wherein the driver stage is controlled via a switch-on causing control signal and the further driver stage is controlled via a further switch-on causing control signal.

24. The apparatus according to claim 16, wherein: at least one third switch with an associated gate control is provided, wherein the gate control is supplied by both of the supply paths via a third coupling element and/or (ii) at least two of the switches are disposed in parallel to one another.

25. The apparatus according to claim 24, wherein at least one of the auxiliary voltage and the further auxiliary voltage is fed to the gate control via at least one decoupling element.

26. The apparatus according to claim 16, wherein an AND connection is fed by at least one of the auxiliary voltage and the further auxiliary voltage, wherein, in the presence of matching switch-off requests as control signals, a respective one of the controls is supplied with the auxiliary voltage or the further auxiliary voltage, via at least one decoupling element.

27. The apparatus according to claim 16, wherein at least one current measurement is provided in each of the supply paths for acquiring current provided by the driver stage or further driver stage.

28. The apparatus according to claim 20, wherein the pulse driver stage includes at least one capacitor having a multiple of system-immanent capacitance of a switch of the switches configured as a field effect transistor, and/or the pulse driver stage includes at least one current source, and/or the pulse driver stage includes at least one switching for recharging a buffer or capacitor, and/or the pulse driver stage includes at least one limiting resistor, and/or the pulse driver stage is configured to initiate a switch-on of the switches using a buffer, and/or a control signal for a switch, which is a component of a constant current source of the pulse driver stage, is fed from a buffer or pulse memory.

29. The apparatus according to claim 17, wherein the current limiter includes at least one resistor and/or a constant current source and/or an RC element and/or a buffered current limiter.

30. The apparatus according to claim 16, further comprising:
at least a first monitoring device configured to monitor at least one of the supply paths for supplying energy to the safety-relevant consumer; and
a further monitoring device, which is independent of the first monitoring device, configured to monitor at least the supply path for the energy supply for the safety-relevant consumer;
wherein the first and further monitoring devices independently of one another monitor at least one respective electrical characteristic variable of the supply path for the energy supply for the safety-relevant consumer for a malfunction and compare each with a respective limit value, wherein a plausibility check is provided in order to generate a switch-off signal for a switch of the switch when both output signals of the first and further monitoring device indicate that the respective limit value has been reached and thus suggest a malfunction, wherein the first and further monitoring devices each include: (i) at least one measuring amplifier for acquiring the respective characteristic variable, and/or (ii) at least one comparator to which an output variable of a respective measuring amplifier is fed, and/or (iii) a memory element to which an output variable of the comparator is fed.
